(19) United States
(12) Patent Application Publication
(10) Pub. No.: US 2023/0109252 A1
(43) Pub. Date: Apr. 6, 2023

(54) COMPUTING SYSTEMS AND METHODS FOR AMASSING AND INTERPRETING DATA FROM A HOME APPLIANCE

(71) Applicant: Haier US Appliance Solutions, Inc., Wilmington, DE (US)

(72) Inventors: Juan Manuel Huerta, Louisville, KY (US); Jeremy Miller, Louisville, KY (US); Abdel Hamad, Louisville, KY (US)

(21) Appl. No.: 17/491,895

(22) Filed: Oct. 1, 2021

(51) Int. Cl. G06N 3/04

(52) U.S. Cl. CPC G06N 3/0454; G05B 13/027

(57) ABSTRACT

A computer implemented method for amassing and interpreting data from a home appliance includes obtaining a plurality of data points that respectively correspond to user data descriptive of usage of a plurality of home appliances, each of the plurality of home appliances being associated with a different user among a plurality of users, processing, by one or more computing devices using a neural network, the plurality of data points to generate a plurality of embeddings associated with the plurality of data points, categorizing the plurality of embeddings to generate clusters of the plurality of users, and determining a predicted event for a new home appliance, the predicted event being based on a categorization of the new home appliance among the clusters of the plurality of users.

### FIELD OF THE INVENTION

The present subject matter relates generally to home appliances, and more particularly to systems and methods for predicting user behavior with respect to home appliances.

### BACKGROUND OF THE INVENTION

Home appliances are increasingly becoming smarter and more connected with the advancement of the internet age. With this, customers are demanding more from their appliances in terms of performance, life expectancy, features, and the like. Refrigerators, cooktop ovens, smart kitchen hubs, dishwashers, and other appliances are beginning to incorporate advanced computing capabilities and software to improve customer satisfaction.

However, current algorithms and applications are unreliable and can be time consuming, inaccurate, and difficult to manage and/or maintain. For instance, data gathered by current applications can be loud (e.g., including excessive unwanted and unusable data) and thus unusable, leading to improper results and customer dissatisfaction.

Thus, a method of improving data collection, organization, representation, and presentation would be useful. In particular, a computing system that is able to extract user data using deep learning methods would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a computer implemented method for amassing and interpreting data from a home appliance is provided. The method may include obtaining a plurality of data points that respectively correspond to user data descriptive of usage of a plurality of home appliances, each of the plurality of home appliances being associated with a different user among a plurality of users; processing, by one or more computing devices using a neural network, the plurality of data points to generate a plurality of embeddings derived from the plurality of data points; categorizing the plurality of embeddings to generate clusters of the plurality of users; and determining a predicted event for a new home appliance, the predicted event being based on a categorization of the new home appliance among the clusters of the plurality of users.

In another exemplary aspect of the present disclosure, computing system for amassing and interpreting data from a home appliance is disclosed. The computing system may include one or more processors and one or more transitory computer-readable media that collectively store instruction that, when executed by the one or more processors, cause the computing system to perform operations. The operations may include obtaining a plurality of data points that respectively correspond to user data descriptive of usage of a plurality of home appliances, each of the plurality of home appliances being associated with a different user among a plurality of users; processing, by one or more computing devices using a neural network, the plurality of data points to generate a plurality of embeddings associated with the plurality of data points; categorizing the plurality of embeddings to generate clusters of the plurality of users; and determining a predicted event for a new home appliance, the predicted event being based on a categorization of the new home appliance among the clusters of the plurality of users.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a connected network of appliances according to exemplary embodiments of the present disclosure.

FIG. 2 illustrates a workflow diagram of an example process for retrieving consumer data according to exemplary embodiments of the present disclosure.

FIG. 3 illustrates a workflow diagram of generating synthetic data according to exemplary embodiments of the present disclosure.

FIG. 4 illustrates a block diagram of an example hardware diagram for a platform run on a computing device according to exemplary embodiments of the present disclosure.

FIG. 5 illustrates a flowchart diagram of an example method for retrieving and processing consumer data according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

According to the present disclosure, systems and methods for analyzing and predicting user behavior are discussed. In detail, using embeddings, a computer system may intelligently determine or predict certain operations, desired outputs, potential failures, and/or behavioral anomalies with increasing accuracy. According to one example, the system may create embeddings from user data associated with particular repeat options selected on a home appliance, e.g., a microwave oven. The embeddings may be categorized into a cluster of users that utilize the same options. In some implementations, synthetic data may be generated and used to bolster the clusters and place new users into appropriate clusters according to limited usage. When the new user is placed into an assigned cluster, certain predictions may be made by the system, for instance, relating to the operations that will be selected by the new user. Thus, predictions on early faults, or desired recipes or food choices, may be made. These predictions may be forwarded to the user or to a technician in preparation for maintenance. Additionally or alternatively, these predictions may be sent to the manufacturer and used to improve functionality of appliances for future iterations.

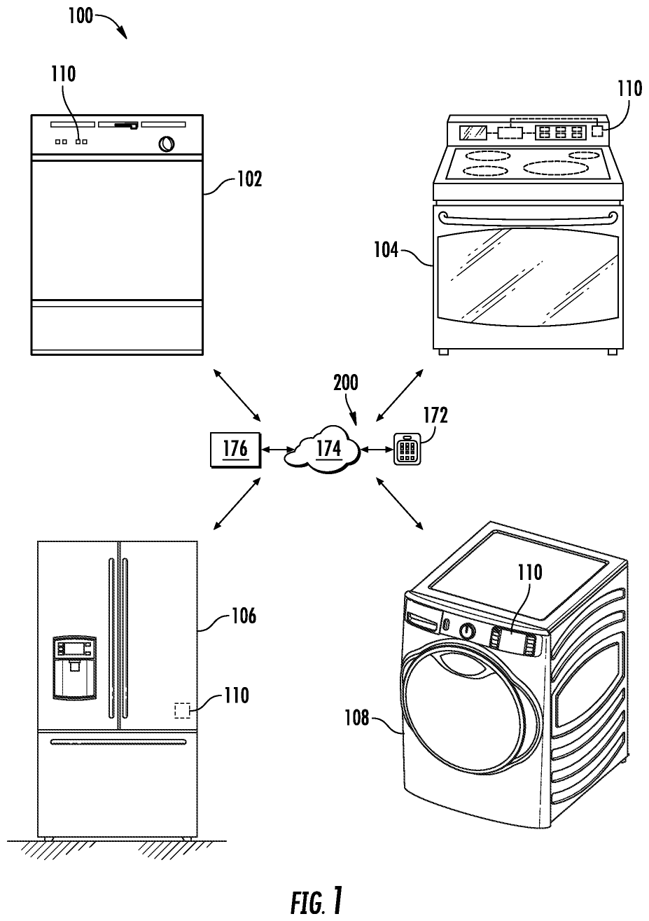

Referring to FIG. 1, a schematic diagram of an external communication system 200 will be described according to an exemplary embodiment of the present subject matter. In general, external communication system 200 is configured for permitting interaction, data transfer, and other communications between one or more appliances 100 and one or more external devices. For example, this communication may be used to provide and receive operating parameters, user instructions or notifications, performance characteristics, user preferences, or any other suitable information for improved performance of the one or more appliances 100. In addition, it should be appreciated that external communication system 200 may be used to transfer data or other information to improve performance of one or more external devices or appliances and/or improve user interaction with such devices.

For example, external communication system 200 permits controller 166 of at least one appliance 100 to communicate with a separate device external to the at least one appliance 100, referred to generally herein as an external device 172. As described in more detail below, these communications may be facilitated using a wired or wireless connection, such as via a network 174. In general, external device 172 may be any suitable device separate from the one or more appliances 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with the one or more appliances 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control the one or more appliances 100, etc. In addition, external device 172 and remote server 176 may communicate with the one or more appliances 100 to communicate similar information.

In general, communication between the one or more appliances 100, external device 172, remote server 176, and/or other user devices or appliances may be carried using any type of wired or wireless connection and using any suitable type of communication network, non-limiting examples of which are provided below. For example, external device 172 may be in direct or indirect communication with the one or more appliances 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 200 is described herein according to an exemplary embodiment of the present subject matter. However, it should be appreciated that the exemplary functions and configurations of external communication system 200 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring still to FIG. 1, a system of connected devices 100 according to exemplary embodiments of the present subject matter is illustrated. As shown, system of connected devices 100 generally includes a first appliance 102 (e.g., illustrated herein as a dishwashing appliance), a second appliance 104 (e.g., illustrated herein as an oven appliance), a third appliance 106 (e.g., illustrated herein as a refrigerator appliance), and a fourth appliance 108 (e.g., illustrated herein as a laundry appliance). Interaction between each of the first appliance 102 and the second appliance 104 will be described below according to exemplary embodiments of the present subject matter. However, it should be understood that the descriptions may apply to any and/or all of connected devices 100 shown. Further, it should be appreciated that the specific appliance types and configurations are only exemplary and are provided to facilitate discussion regarding the use and operation of an exemplary system of connected devices 100. The scope of the present subject matter is not limited to the number, type, and configurations of appliances set forth herein. Moreover, detailed descriptions of each particular appliance will be omitted for brevity.

For example, the system of connected appliances 100 may include any suitable number and type of “appliances,” such as “household appliances.” These terms are used herein to describe appliances typically used or intended for common domestic tasks, e.g., such as laundry appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions in addition to network communication and data processing. Moreover, although only two appliances are illustrated, various embodiments of the present subject matter may also include three or more appliances, each of which may transmit, receive, and/or relay signals among connected appliances and/or other external devices.

As illustrated, each of first appliance 102, second appliance 104, remote user interface device 172, or any other devices or appliances in system of connected appliances 100 may include or be operably coupled to a controller, identified herein generally by reference numeral 110. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 110 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 110 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 110 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 110 as disclosed herein is capable of and may be operable to perform any methods, method steps, or portions of methods as disclosed herein. For example, in some embodiments, methods disclosed herein may be embodied in programming instructions stored in the memory and executed by controller 110. The memory devices may also store data that can be retrieved, manipulated, created, or stored by the one or more processors or portions of controller 110. The data can include, for instance, data to facilitate performance of methods described herein. The data can be stored locally (e.g., on controller 110) in one or more databases and/or may be split up so that the data is stored in multiple locations. In addition, or alternatively, the one or more database(s) can be connected to controller 110 through any suitable communication module, communication lines, or network(s).

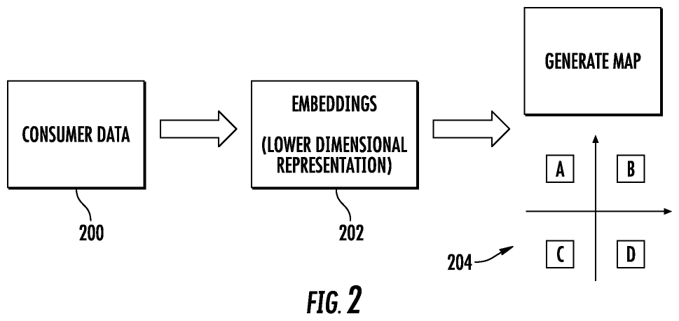

FIG. 2 illustrates a flow chart of collecting input data 200 and generating embeddings 202 for the input data 200 (e.g., consumer data) collected from the system of connected appliances 100. The input data 200 may include different types, forms, or variations of input data. As examples, in various implementations, the input data 200 may include consumer data such as sensor reading (e.g., pressure sensors, temperature sensors, humidity sensors, seismic sensors, etc.), software revision reporting, fault code information, appliance operating mode (e.g., dishwasher operations, washing machine operations, etc.), cycle specific and option selection information, and the like. In additional or alternative implementations, the input data 200 may include product user data such as consumable usage (e.g., dishwasher detergent pods, laundry detergent, filters, etc.), notifications on low levels of consumables, cycles status, and the like. It should be noted that any suitable data from any suitable appliance may be incorporated as input data 200.

In some implementations, one or more neural networks may be used to provide an embedding 202 based on the input data 200. For example, the embedding 202 can be a representation of knowledge abstracted from the input data 202 into one or more learned dimensions. In some instances, embeddings 202 can be a useful source for identifying related entities (e.g., data points from input data 200). In some instances, embeddings 202 can be extracted from the output of the network, while in other instances embeddings 202 can be extracted from any hidden node or layer of the network (e.g., a close to final but not final layer of the network). Embeddings 202 may be useful for generating clusters of users, clusters of failure points, product suggestions, recipe suggestions, entity or object recognition, etc. In some instances, embeddings 202 may be useful inputs for downstream models. For example, embeddings 202 may be useful to generalize input data 200 (e.g., search queries) for a downstream model or processing system. In some implementations, the machine-learned model can be used to preprocess the input data 200 for subsequent input into another model. For example, the machine-learned model can perform dimensionality reduction techniques and embeddings (e.g., matrix factorization, principal components analysis, singular value decomposition, word2vec/GLOVE, and/or related approaches); clustering; and even classification and regression for downstream consumption.

In some implementations, the machine-learned model can perform various types of clustering. For example, the machine-learned model can identify one or more previously-defined clusters to which the input data most likely corresponds. As another example, the machine-learned model can identify one or more clusters within the input data 200. That is, in instances in which the input data 200 includes multiple objects, documents, or other entities, the machine-learned model may sort the multiple entities included in the input data 200 into a number of clusters. In some implementations in which the machine-learned model performs clustering, the machine-learned model can be trained using unsupervised learning techniques. In some implementations, the machine-learned model may perform anomaly detection or outlier detection. For example, the machine-learned model may identify input data 200 that does not conform to an expected pattern or other characteristic (e.g., as previously observed from previous input data). As an example, the anomaly detection may be used for system failure detection.

In some implementations, the machine-learned model may receive and use the input data 200 in its raw form. In some implementations, the raw input data can be preprocessed. Thus, in addition or alternatively to the raw input data, the machine-learned model may receive and use the preprocessed input data.

In some implementations, the machine-learned model may be or include one or more generative networks such as, for example, generative adversarial networks (as will be described in more detail below). Generative networks may be used to generate new data such as new images or other content.

In some implementations, the machine-learned model may be or include an autoencoder. In some instances, the aim of an autoencoder is to learn a representation (e.g., a lower-dimensional encoding) for a set of data, typically for the purpose of dimensionality reduction. For example, in some instances, an autoencoder may seek to encode the input data and then provide output data that reconstructs the input data from the encoding. Recently, the autoencoder concept has become more widely used for learning generative models of data. In some instances, the autoencoder can include additional losses beyond reconstructing the input data.

In some implementations, the machine-learned model may be or include one or more other forms of artificial neural networks such as, for example, deep Boltzmann machines; deep belief networks; stacked autoencoders; etc. Any of the neural networks described herein can be combined (e.g., stacked) to form more complex networks.

In some implementations, the input to the machine-learned model(s) of the present disclosure may be latent encoding data (e.g., a latent space representation of an input, etc.). The machine-learned model(s) may process the latent encoding data to generate an output. As an example, the machine-learned model(s) may process the latent encoding data to generate a recognition output. As another example, the machine-learned model(s) may process the latent encoding data to generate a reconstruction output. As another example, the machine-learned model(s) may process the latent encoding data to generate a search output. As another example, the machine-learned model(s) may process the latent encoding data to generate a reclustering output. As another example, the machine-learned model(s) may process the latent encoding data to generate a prediction output.

In some implementations, the input to the machine-learned model(s) of the present disclosure may be sensor data. The machine-learned model(s) may process the sensor data to generate an output. As an example, the machine-learned model(s) may process the sensor data to generate a recognition output. As another example, the machine-learned model(s) may process the sensor data to generate a prediction output. As another example, the machine-learned model(s) may process the sensor data to generate a classification output. As another example, the machine-learned model(s) may process the sensor data to generate a segmentation output. As another example, the machine-learned model(s) may process the sensor data to generate a segmentation output. As another example, the machine-learned model(s) may process the sensor data to generate a visualization output. As another example, the machine-learned model(s) may process the sensor data to generate a diagnostic output. As another example, the machine-learned model(s) may process the sensor data to generate a detection output.

Referring again to FIG. 2, in response to receipt of the input data, the machine-learned model may provide the output data. The output data may include different types, forms, or variations of output data. As examples, in various implementations, the output data may include one or more maps including clusters of similar embeddings. For example, the machine-learned model may, upon processing the input data 200 as a plurality of data points, sort the processed data (e.g., embeddings) according to clusters as visualized on a 2- or 3-dimensional map. As seen in FIG. 2, the machine-learned model may categorize a user (or a new home appliance) into one of cluster A, cluster B, cluster C, or cluster D. Accordingly, the machine-learned model may make a prediction as to operating characteristics most likely to be displayed or exhibited by the new home appliance. It should be noted that in some implementations, more or fewer cluster regions may be generated, and the disclosure is not limited to the example shown here.

In some implementations, the output data may include predictions. For example, the machine-learned model may process input data 200 related to failures of related home appliances (e.g., failure of a refrigeration coil of a refrigerator appliance). Upon determining that the new home appliance is near a cluster that exhibits a particular failure point, the machine-learned model may predict a failure point of the new home appliance. Accordingly, the new user may be notified as to a potential failure. Additionally or alternatively, one or more repair technicians may be alerted as to the potential for failure, and appropriate diagnostic action may be taken. In some instances, a repair call may be scheduled automatically in prediction of a failure. Additionally or alternatively, repair items may be ordered, or a prompt may be sent to the user to order repair items. It should be noted that the embodiments described herein are not limited to the examples discussed above, and that the machine-learned model may process and sort users and/or new appliances according to any suitable metrics.

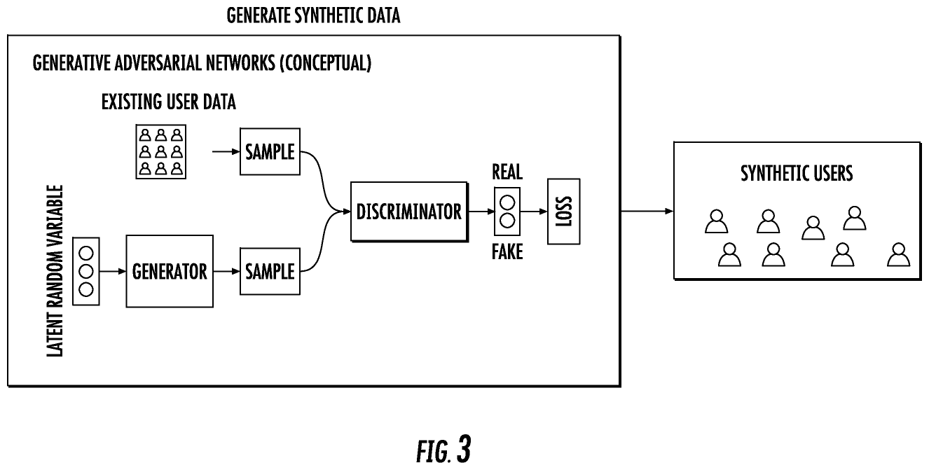

As shown in FIG. 3, the machine-learned model may generate synthetic data to be used to further train the model in analyzing new data. In at least some examples, generative adversarial networks (GAN) may be utilized. GANs may be neural networks that learn to create synthetic data similar to known input data 200. For instance, known data points may be input to a discriminator network to be compared with generated data points. The discriminator network may then determine the difference between the generated data points and the known data points. Through iteration, the discriminator network learns aspects of the known data points. A generator network may then utilize the learned features of the discriminator network to generate synthetic data points. GANs may then generate data points that can supplement real data points in generating clusters and predicting events.

Returning briefly to FIG. 2, the machine-learned model may transmit the latent space, 2- or 3-dimensional map to a mobile device (e.g., mobile device 172). For instance, the mobile device may include a display 180 (e.g., a liquid crystal display, a light emitting diode display, etc.). A user (e.g., a technician) may then view the clusters. According to some implementations, the user may choose to observe clusters according to selected traits or based on selected input data 200. Additionally or alternatively, the machine-learned model may predict recommendations and/or alerts. For instance, the machine-learned model may determine that a new user belongs to a cluster that normally uses certain ingredients in recipes. Thus, the prediction may result in recommendations on recipes or ingredients to purchase or use. Further, the machine-learned model may provide recommended purchase offers on additional appliances according to a cluster placement.

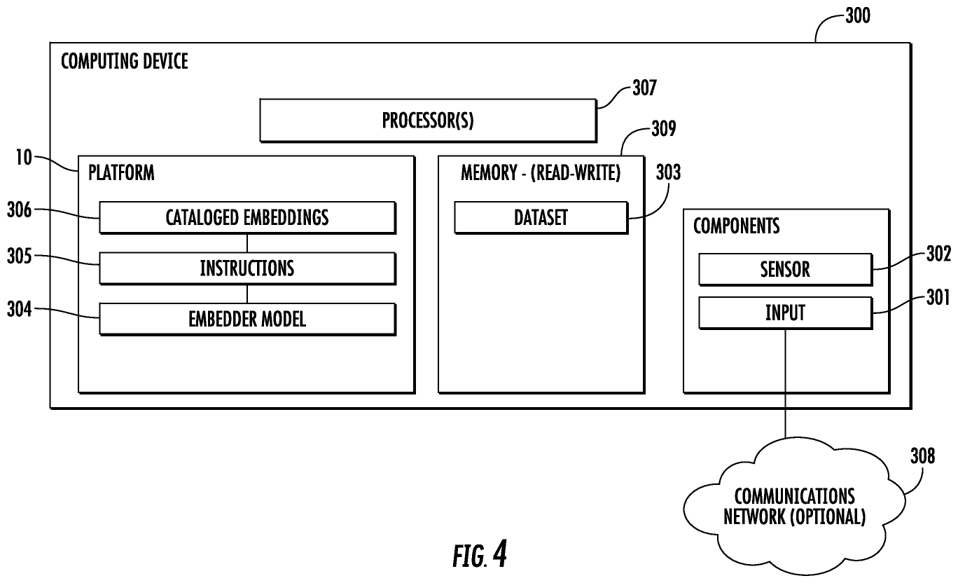

FIG. 4 illustrates an example hardware diagram for a platform 10 run on a computing device 300. In some embodiments, computing device is provided in or on mobile device 172. The computing device 300 may include one or more processors 307 that can execute computer readable instructions 305 for utilizing components that include, for example, a sensor 302 and an input (e.g., button, knob, selector, etc.) 301. Examples of these instructions include methods for retrieving a dataset 303, processing the dataset 303 using an embedder model 304, and accessing cataloged embeddings 306. In some embodiments, a communications network 308 (e.g., similar to or different from external communications system 200 described above) may provide a conduit for the computing device 300 to receive the dataset 303. Generally, computing devices 300 may include smartphones, tablets, laptops, and desktop computers, as well as other locally or remotely connected devices (e.g., mobile device 172) which could be capable of interacting with a communications network 308. As an example, the computing device 300 may include a smart phone containing a processor 307 as well as the platform 10 as a downloaded application. Upon receiving input data 200 from, e.g., sensor 302, the input data 200 may be preprocessed or used as is. The smartphone may access the platform 10 as an application to run the instructions for receiving the input data 200 and processing the input data 200 to generate an embedding 202. In some computing devices, the platform may perform these steps automatically after the sensor is triggered or any time the input is used.

Embodiments of the disclosure may include training systems on the computing device 300 or that can be accessed through the communications network 308. The training computing system may include one or more processors 307 and a memory 309. The one or more processors 307 may be any suitable processing device (e.g., a processor core, a microprocessor, an ASIC, a FPGA, a controller, a microcontroller, etc.) and may be one processor or a plurality of processors that are operatively connected. The memory 309 may include one or more non-transitory computer-readable storage mediums, such as RAM, ROM, EEPROM, EPROM, flash memory devices, magnetic disks, etc., and combinations thereof. The platform 10 may include instructions 305 which are executed by the processor 307 to cause the training computing system to perform operations. In some implementations, the training computing system includes or is otherwise implemented by one or more server computing devices.

The model trainer may include computer logic utilized to provide desired functionality. The model trainer may be implemented in hardware, firmware, and/or software controlling a general purpose processor. For example, in some implementations, the model trainer includes program files stored on a storage device, loaded into a memory and executed by one or more processors. In other implementations, the model trainer includes one or more sets of computer-executable instructions that are stored in a tangible computer-readable storage medium such as RAM hard disk or optical or magnetic media.

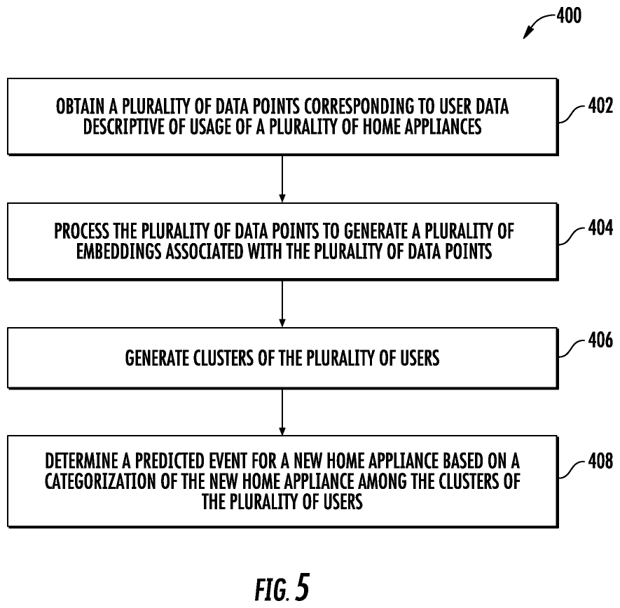

Referring now to FIG. 5, a computer implemented method 400 for amassing data from a home appliance will be discussed. At step 402, method 400 may include obtaining a plurality of data points corresponding to user data descriptive of usage of a plurality of home appliances. Each of the plurality of data points may respectively correspond to a separate home appliance, a separate user, a separate geographic location, etc. For instance, each home appliance of the plurality of home appliances may be associated with a different user among a plurality of users. The plurality of data points may include collected consumer data from the plurality of home appliances. In at least one example, the plurality of data points includes sensor readings, software revision reporting, fault code information, operating mode(s), cycle and/or option information, user preferences, or the like.

In at least some implementations, each of the plurality of home appliances may incorporate one or more sensors attached thereto to detect and transmit the data points. For example, door switches, temperature sensors, humidity sensors, speed sensors, transducers, pressure sensors, or the like may be incorporated into the plurality of home appliances. Each of these sensors may produce data points corresponding to usage patterns, particular behaviors in certain clustered users, and typical habits within the clusters of users. Additionally or alternatively, the sensors may provide useful data points related to failure points, common faults, and systematic failures, particularly at scale.

At step 404, method 400 may include processing the plurality of data points to generate a plurality of embeddings associated with the plurality of data points. For example, as described above, one or more computing devices using a neural network may be used to process the plurality of data points. Processing the plurality of data points may be accomplished using an embedder model. Examples of the embedder model include artificial neural networks such as feed-forward neural networks, recurrent neural networks (e.g., long short-term memory recurrent neural networks), convolutional neural networks, or other forms of neural networks. Additionally, generating the embedding may use one or more of the hidden layers of the artificial neural network to generate the embedding.

According to some implementations, the processing of the plurality of data points includes generating a dimensional vector for each data point. As described briefly above, the data points may be embedded as dimensional vectors within a latent space. The embeddings may reduce the number of dimensions associated with each vector in order to generate more usable data (e.g., without noise). Accordingly, a representation of each data point may be generated within the embedding, which may then be used, e.g., at step 406. Additionally or alternatively, each representation may be analyzed in order to generate relationships, or proximity, of representations within the latent space. Accordingly, similar representations may be placed closer together.

At step 406, method 400 may include generating clusters of the plurality of users. In detail, the embeddings may be categorized (e.g., by the one or more computing devices) according to predetermined guidelines or a predetermined scope to generate appropriate clusters. For example, according to at least one implementation, certain users may wish to receive recommendations on food items, recipes, or additional appliances based on what similar users use. Thus, the embeddings of the data points may be clustered accordingly to generate clusters of users that typically use the same ingredients or appliances when cooking. A new user may be placed into that cluster (e.g., using separate embeddings related to other activities, or by using synthetic data created by GANs), allowing pertinent recommendations to be made to the new user. It should be noted that this is merely an example, and users (or embeddings or data points) may be clustered in multiple ways to generate different usable data.

At step 408, method 400 may include determining a predicted event for a new home appliance based on a categorization of the new home appliance among the clusters of the plurality of users. As mentioned above, clusters may be generated according to specific requests or requirements to provide different forms of usable data to users. According to another implementation, for example, the embeddings may be clustered according to usage patterns and/or geographic locations. In detail, for certain home appliances (e.g., refrigerator appliances, air conditioner appliances, etc.), users in warmer clients tend to see heavier loads placed on these appliances throughout their lifetime. By clustering users together according to usage patterns (or by geography) and observing failure points, the system may predict a failure event for a new user placed into that cluster, e.g., through the embedding. This is turn may provide a more seamless repair or maintenance operation, or in some cases, lead to an adjustment of usage of the appliance to prolong life or reduce failures. A plurality of predicted events may be determined depending on the clusters generated, the embeddings generated, and/or the data points obtained and processed. Other predictions may include operation times of certain home appliances, warm up/cool down periods, anticipated shopping trips, food items purchased by time of year, or the like. Additionally or alternatively, usage data associated with the plurality of home appliances may be processed to generate embeddings for use by the manufacturer to improve design, construction, and operation of the home appliances.

In any of the above embodiments, the system may receive the data points from multiple users and process the dataset using an embedding model to generate the embedding for the data point. As an example embodiment, the embedding model may be an artificial neural network such as, for example, a convolutional neural network. The embedding model may be trained (e.g., via a triplet training scheme) to produce embeddings for objects in an embedding dimensional space, where a magnitude of a distance between two embeddings for two objects is inversely correlated with a similarity between the two objects. In some embodiments, the platform may include a single embedding model while in other embodiments multiple different embedding models can be used. For example, different embedding models may be used which are respectively trained to be specific to different types, domains, or classes of objects. As one example, the platform may use a first embedding model for general objects but a second, specialized embedding model for food or food dishes.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Thus, while the present subject matter has been described in detail with respect to various specific example implementations, each example is provided by way of explanation, not limitation of the disclosure. One of ordinary skill in the art can readily make alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer implemented method for amassing and interpreting data from a home appliance, the method comprising:
obtaining a plurality of data points that respectively correspond to user data descriptive of usage of a plurality of home appliances, each of the plurality of home appliances being associated with a different user among a plurality of users;
processing, by one or more computing devices using a neural network, the plurality of data points to generate a plurality of embeddings derived from the plurality of data points;
categorizing the plurality of embeddings to generate clusters of the plurality of users; and
determining a predicted event for a new home appliance, the predicted event being based on a categorization of the new home appliance among the clusters of the plurality of users.

2. The computer implemented method of claim 1, wherein the processing, by the one or more computing devices using the neural network, the plurality of data points to generate the plurality of embeddings comprises:
generating a dimensional vector for each data point; and
reducing, via the neural network, the number of dimensions associated with each vector to establish a representation of each data point.

3. The computer implemented method of claim 2, wherein the processing, by the one or more computing devices using the neural network, the plurality of data points to generate the plurality of embeddings comprises:
analyzing each representation of the plurality of data points to generate relationships between similar representations.

4. The computer implemented method of claim 3, wherein the processing, by the one or more computing devices using the neural network, the plurality of data points to generate the plurality of embeddings comprises creating synthetic data via a generative adversarial network.

5. The computer implemented method of claim 3, wherein the categorizing the plurality of embeddings to generate clusters of the plurality of users comprises displaying, on a display device, a map of the representations within distinct categories.

6. The computer implemented method of claim 5, wherein the plurality of data points comprises usage data, failure data, geographic location of a respective home appliance, and user preferences.

7. The computer implemented method of claim 6, wherein a first cluster of the clusters generated by categorizing the plurality of embeddings comprises embeddings of users that are closest together based on failure data.

8. The computer implemented method of claim 7, wherein the predicted event is a predicted fault code based on the failure data of the first cluster of embeddings.

9. The computer implemented method of claim 7, wherein a second cluster of the clusters generated by categorizing the plurality of embeddings comprises embeddings of users that are closest together based on maintenance performed on the plurality of home appliances.

10. The computer implemented method of claim 9, wherein the predicted event is a predicted maintenance event based on the maintenance performed on the plurality of home appliances.

11. A computing system for amassing and interpreting data from a home appliance, the computing system comprising:
one or more processors; and
one or more transitory computer-readable media that collectively store instruction that, when executed by the one or more processors, cause the computing system to perform operations, the operations comprising:
obtaining a plurality of data points that respectively correspond to user data descriptive of usage of a plurality of home appliances, each of the plurality of home appliances being associated with a different user among a plurality of users;
processing, by one or more computing devices using a neural network, the plurality of data points to generate a plurality of embeddings associated with the plurality of data points;
categorizing the plurality of embeddings to generate clusters of the plurality of users; and
determining a predicted event for a new home appliance, the predicted event being based on a categorization of the new home appliance among the clusters of the plurality of users.

12. The computing system of claim 11, wherein the processing, by the one or more computing devices using the neural network, the plurality of data points to generate the plurality of embeddings comprises:
generating a dimensional vector for each data point; and
reducing, via the neural network, the number of dimensions associated with each vector to establish a representation of each data point.

13. The computing system of claim 12, wherein the processing, by the one or more computing devices using the neural network, the plurality of data points to generate the plurality of embeddings comprises:
analyzing each representation of the plurality of data points to generate relationships between similar representations.

14. The computing system of claim 13, wherein the processing, by the one or more computing devices using the neural network, the plurality of data points to generate the plurality of embeddings comprises creating synthetic data via a generative adversarial network.

15. The computing system of claim 13, wherein the categorizing the plurality of embeddings to generate clusters of the plurality of users comprises displaying, on a display device, a map of the representations within distinct categories.

16. The computing system of claim 15, wherein the plurality of data points comprises usage data, failure data, geographic location of a respective home appliance, and user preferences.

17. The computing system of claim 16, wherein a first cluster of the clusters generated by categorizing the plurality of embeddings comprises embeddings of users that are closest together based on failure data.

18. The computing system of claim 17, wherein the predicted event is a predicted fault code based on the failure data of the first cluster of embeddings.

19. The computing system of claim 17, wherein a second cluster of the clusters generated by categorizing the plurality of embeddings comprises embeddings of users that are closest together based on maintenance performed on the plurality of home appliances.

20. The computing system of claim 19, wherein the predicted event is a predicted maintenance event based on the maintenance performed on the plurality of home appliances.
